(19) United States
(12) Patent Application Publication
(10) Pub. No.: US 2002/0130518 A1
(43) Pub. Date: Sep. 19, 2002

(54) Sure-lock gasket coupling

(76) Inventors: Mark Thomas, Amarillo, TX (US); Paul Thomas, Amarillo, TX (US)

Correspondence Address: Mark Thomas, 1611 Mustang, Amarillo, TX, 79102, US

(21) Appl. No.: 09/771,605

(22) Filed: Jan. 30, 2001

(51) Int. Cl. F16L 25/00

(52) U.S. Cl. 285/420

(57) ABSTRACT

A gasket coupling clamp for pipe joining of the type having a gasket coupling body (4) formed at opposing ends with male threads (7) which communicate with female threads (8) of a nut (3). A rubber gasket (5) is sand-witched between said nut and said coupling body to compress around pipe ends as each pipe end is inserted into said nut and through said rubber gasket and into said coupling body providing a seal. Each said nut is cast with a stationary pipe clamp (1) which communicates directly with each pipe respectively, as a rotating pipe clamp (2) is rotated around a bolt (6) and aligns over the pipe directly opposite the said stationary pipe clamp and rests against another bolt (6) in a open latch receiver (10) formed on one end of the said rotating pipe clamp. The said bolts respectively are tightened clockwise into threaded holes (9) which in turn pinches the respective pipes into a locked position.

### CROSS-REFERENCE TO RELATED APPLICATIONS

Not applicable.

### BACKGROUND

1. Field of Invention

This invention relates to gasket couplings, specifically to such couplings which are used during the process of pipe connection repairs.

2. Description of Prior Art

The invention herein disclosed deals with a pipe coupling for connecting two pipes utilized as a conduit of a liquid or gas wherein the pressure would be greater internal to the piping as opposed to the external pressure. The prior art is quite extensive with patents directed to coupling methods used to assemble pipes. Many applications for connecting pipes require time consuming and costly processes such as welding or soldering, as well as various metals or plastics that are common in the industry. Thus, to employ this novel coupling will be both cost effective, and time saving.

The couplings most commonly used in the industry today require various processes to be undertaken by the individual skilled in the art of pipe fitting to allow for the proper seal to be accomplished. Many methods require the pipe ends to be threaded, notched, flared, or even bead welded. The coupling system which utilizes a pair of rubber gaskets which are compressed around the external portion of each of the two pipes being joined, and then enclosed in a sleeve by two opposing nuts is very successful in obtaining a no-leak piping coupling. However, with the pressure internal to the piping system, this coupling has tendency to allow the pipes to separate. As the pipes continue to separate the system fails and a leak occurs.

It would be beneficial if the pipes required no prior threading, notching, flaring, soldering or welding in order to make a leak free joint. This would be an advantage to have a coupling system which would be time and cost efficient, while also preventing the opposing ends of the piping from being slide-able in the coupling due to the internal pressure and temperature fluctuations of the system it has been attached to. All of these advantages can be obtained with this present invention.

Inventors have created numerous coupling systems designed to join pipes and conduit in a way as to be leak free. U.S. Pat. No. 5,240,294 to Cocoran (1993) discloses a pipe coupling with bolt pads and linear extending lugs; however, this coupling required forming a metal deformation on the outside surface of each pipe segment, at a predetermined distance from each pipe end, to obtain prepared pipe ends. The invention of this sure-lock gasket coupling will allow the one skilled in the art of pipe fitting to make a reliable leak-free connection without the need to prepare the pipe end being joined. U.S. Pat. No. 5,230,537 to Newman (1993) discloses a pipe coupling comprising a sealing gasket to fit over adjacent ends of pipes to be connected end-to-end and a housing which clamps around the gasket, the same of which becomes the seal as well as the means of restraining movement of the pipes which it is joining; however, this coupling system, while accomplishing the seal, relies on the sealing gasket to retain the pipes in a stationary position. As the gasket seal ages and the pressure and possible temperature of the product being conveyed in the piping fluctuates, the gasket seal will tend to release the grip on the piping, having been conformed for an extended time frame to the confines of the clamp.

Although the gasket coupling systems heretofore mentioned, as well as all of the prior art may provide leak-free joining of piping there are numerous disadvantages:

(a) Many of the couplings require a large space with which to install the coupling system.

(b) Many of the couplings require the person skilled in the art of pipe fitting to weld or solder by means of gas or arc; this being time consuming as well as presenting a problem with the dangers as to the product which the piping is being used to convey, if the act of coupling is being made as a repair.

(c) Many of the couplings require the pipes to be threaded, flared, primed or notched, which is costly for the person performing the pipe joining because of the tooling and equipment required.

(d) Although the coupling systems available today will succeed in providing a leak-free joint, there remains a problem of preventing the pipes from being slide-able to the point of separation from the coupling resulting in a leak pursuant to the joining being made, and the craftsman being long removed from the place of work.

### SUMMARY

In accordance with the present invention a gasket coupling clamp comprises one coupling body, two rubber gaskets, two nuts which are each cast with the top half of a pipe clamp designated as stationary pipe clamps, four bolts and two bottom halves of a pipe clamp designated as rotating pipe clamps.

Objects and Advantages

Accordingly, several objects and advantages of the present invention are:

(a) to provide a gasket coupling which will require a minimal of space in order to install.

(b) to provide a gasket coupling which will require no preparation of the pipe end which are being coupled.

(c) to provide a gasket coupling which will not require costly equipment such as welders, torches and threading tools.

(d) to provide a gasket coupling which will attain a positive clamp around the piping, preventing the pipes being coupled from separating due to the internal pressure of the system.

(e) to provide a gasket coupling which allows repair coupling to be made without the need to purge the system of water or other possible contents before making the coupling.

(f) to provide a gasket coupling which may be cast from bronze, PVC, ABS or steel, allowing this coupling to be incorporated into many various systems.

(g) to provide a gasket coupling which may be closed and reopened without damage to the coupling.

(h) to provide a gasket coupling which may be cast to accept piping of differing sizes to be joined, as well as differing materials.

Further objects and advantages are to provide a gasket coupling clamp which may also be cast in various angles such as 90 degree, 45 degree and even a tee combination which would allow for the tapping into an existing system to run another branch.

### DRAWING FIGURES

The invention is shown in five separate drawings.

FIG. 1 is an exploded side view of the invention as it would be used to couple pipes together.

FIG. 2 is a perspective view of the nut and clamp assembly depicting the method in which the invention is assembled.

FIG. 3 depicts the present invention used as a “TEE” fitting.

FIG. 4 depicts the present invention used as an elbow.

FIG. 5 depicts the present invention used as a termination cap.

Reference Numerals In Drawings

| | |
|---|---|
| 1 | stationary pipe clamp |
| 2 | rotating pipe clamp |
| 3 | nut |
| 4 | coupling body |
| 5 | rubber gasket |
| 6 | bolt |
| 7 | male threads |
| 8 | female threads |
| 9 | hole with female threads |
| 10 | open latch receiver |
| 11 | hole no threads |

### DESCRIPTION

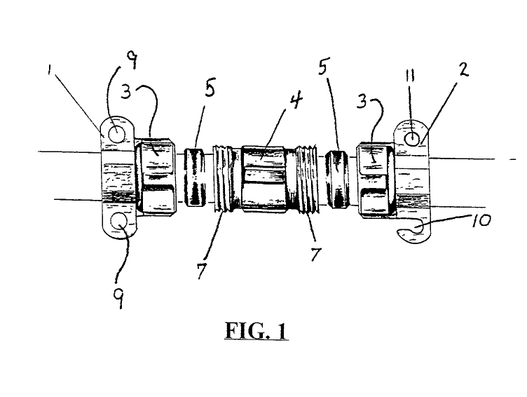

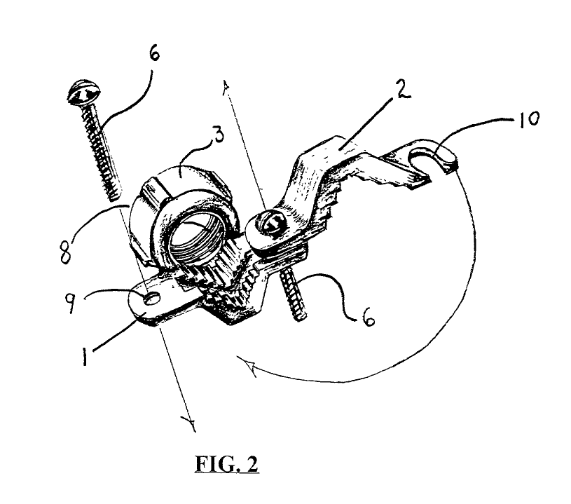

FIGS. 1 and 2—Preferred Embodiment

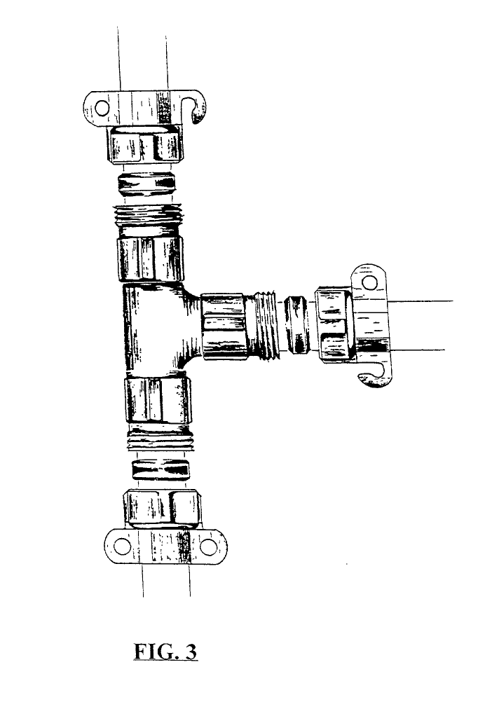

A preferred embodiment of the present invention is illustrated in FIG. 1. A gasket coupling has a body 4 of cylinder shape large enough to fit over pipes to be joined. Each end of a body 4 has male threads 7 designed to receive female threads 8 of a nut 3. A rubber gasket 5 is fitted over each separate piece of pipe to be joined, and a nut 3 is turned onto a body 4 compressing a rubber gasket 5 around the pipes being joined. Cast as an integral part of a nut 3 is a stationary pipe clamp 1 which is designed to clamp onto a pipe being joined when a rotating pipe clamp 2 which is rotated around a bolt 6, shown in FIGS. 2 and 3, to align with a second bolt 6 in a open latch receiver 10. A stationary pipe clamp 1 has two holes with female threads 9 which receive a set of bolts 6. A rotating pipe clamp 2 is fitted with a hole with no threads 11 on one side which is larger than the diameter of a bolt 6 to allow unrestrained motion until a bolt 6 is tightened into the securing position, where a slotted head of a bolt 6 then rests on the surface of a rotating pipe clamp 2 and as a bolt 6 is tightened into a hole with female threads 9. The opposite end of a rotating pipe clamp 2 is a open latch receiver 10 designed to allow a rotating pipe clamp 2 to rotate over a pipe and a stationary pipe clamp 1 while a bolt 6 is in a slightly loose position in a hole with female threads 9 of a stationary pipe clamp 1, after which a bolt 6 is then tightened into a stationary pipe clamp 1 resulting in a clamping of the pipes being joined. Thus insuring a positive locking together of the pipes mechanically by an entire gasket coupling invention.

FIGS. 4-6—-Alternative Embodiments

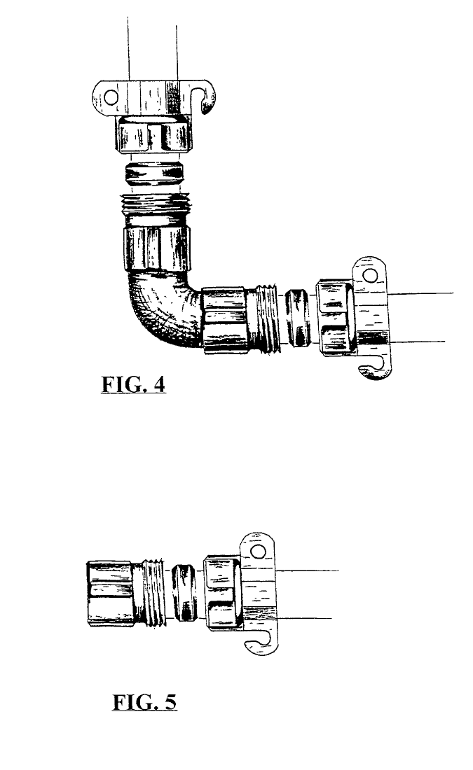

There are various possibilities with regard to the fittings which this present invention may be applied to, as illustrated in FIG. 3 which shows a sure-lock gasket coupling tee. In FIG. 4 a sure-lock gasket coupling is incorporated into an elbow. FIG. 5 depicts a sure-lock gasket coupling as a termination cap.

Operation-FIGS. 1-5

The manner of using the gasket coupling clamp for joining pipes is identical to methods in common use with the exception of the improvement of the clamp assembly incorporated in the present invention. First, a gasket coupling clamp must be taken apart in preparation of fastening two pipe ends together, this is done by rotating the nut 3 counterclockwise while holding the coupling body 4 until the nut 3 separates from the body 4. Next, one must remove the rubber gasket 5 which was encased between the nut 3 and the body 4, this procedure must be repeated for the opposing end of the gasket coupling. Next, one must rotate the bolt 6 counterclockwise until the rotating pipe clamp 2 is free to rotate up and away from the stationary pipe clamp 1 to allow room for the pipe to be inserted into the nut 3, this procedure must be repeated for the opposing end of the gasket coupling also. After each of the nut 3 and stationary pipe clamp 1 and rotating pipe clamp 2 assemblies have been prepared, the pipe is then inserted into the nut 3 to a depth sufficient to next place the rubber gasket 5 over each end of the pipes. Once this is accomplished, the coupling body 4 is aligned with the nut 3 at each end, receiving the pipes into the coupling body 4 with the rubber gasket 5 being compressed between the nut 3 and the coupling body 4 around each of the pipe ends being joined. The nut 3 is then rotated clockwise around the coupling body 4 to a torque pressure sufficient to compress the rubber gasket 5 to conform to the surface of the pipes producing the desired seal. After each end of the joining has been completed, one must rotate the rotating pipe clamp 2 around to the position which allows the open latch receiver 10 to engage the bolt 6 at which point a screwdriver is used to begin rotating the bolt 6 clockwise to begin lowering the rotating pipe clamp 2 downward to contact the pipe. Each bolt 6 is then adjusted to evenly draw the rotating pipe clamp 2 upon the pipe until the pipe is restrained from any ability to be withdrawn from the gasket coupling. The process is repeated identically for the opposing end over the other pipe to be joined, thus creating a leak free and pipe clamped joint.

Conclusion, Ramifications, and Scope

Accordingly, the reader will see that the gasket coupling clamp of the invention can be used to accomplish a positive joining of piping for leak free joints, with the ability to prevent the possibility of the joined pipes pulling apart. In addition, this current invention allows the joined pipes to be disjoined without damage to either the gasket coupling clamp or the pipes with which the gasket coupling clamp was joining.

It permits the production of various other combinations of angled fittings to be joined using the clamping ability to insure positive joining.

It permits the production of various other materials, such as but not limited to ABS, PVC, Brass, Bronze and steel to be used in the manufacturing of this invention to allow a wide field of use.

It provides a method of coupling pipes which requires no previous work to prepare the pipe ends being joined.

Although the description above contains many specifics, these should not be construed as limiting the scope of the invention but as merely providing illustrations of some of the presently preferred embodiments of this invention. For example, the embodied invention may also be manufactured in many of the various pipe sizes, or in multiple size ports in a tee fitting, to receive and couple differing pipe sizes being connected together.

Thus the scope of the invention should be determined by the appended claims and their legal equivalents, rather than by the examples given.

I claim:

1. In a gasket coupling clamp of the type comprising a coupling body of material having a male thread at opposite ends of said coupling body receiving a rubber gasket at opposite ends of said coupling body, as a means of sealing around a set of pipes being coupled, while a nut having female threads communicating with said male threads at said opposite ends of said coupling body being rotated onto said male threads of said coupling body compress said rubber gaskets around said pipes being joined, the improvement wherein a stationary pipe clamp is fashioned onto said nuts at opposite ends of said coupling body communicating with a rotating pipe clamp with a pair of bolts passing through said pipe clamps so that said rotating pipe clamp is urged toward said stationary pipe clamp by rotating said bolts clockwise, thereby compressing said stationary pipe clamp and said rotating pipe clamp around the pipes being joined providing means of restricting motion of pipes in said coupling body.

2. The gasket coupling clamp of claim 1 wherein said coupling body material may be composed of brass, steel or polyvinyl chloride.

3. The gasket coupling clamp of claim 1 wherein said coupling clamp is formed as a tee fitting.

4. The gasket coupling clamp of claim 1 wherein said coupling clamp is formed as an elbow.

5. The gasket coupling clamp of claim 1 wherein said coupling clamp is formed as a termination cap.
